(19) United States
(12) Patent Application Publication
(10) Pub. No.: US 2024/0157817 A1
(43) Pub. Date: May 16, 2024

(54) VEHICLE

(71) Applicant: SUBARU CORPORATION, Tokyo (JP)

(72) Inventors: Ryuya SUZUKI, Tokyo (JP); Norio SUZUKI, Tokyo (JP)

(21) Appl. No.: 18/383,767

(22) Filed: Oct. 25, 2023

(30) Foreign Application Priority Data
Nov. 14, 2022 (JP) 2022-181755

(51) Int. Cl. B60L 50/64; A62C 3/06; A62C 3/07; A62C 3/16; H01M 50/317

(52) U.S. Cl. CPC B60L 50/64; A62C 3/06; A62C 3/07; A62C 3/16; H01M 50/317; H01M 2220/20

(57) ABSTRACT

A vehicle includes a high-voltage battery pack, a charge port, and a smoke exhaust duct. The high-voltage battery pack includes a smoke exhaust port and a valve part. The valve part is configured to close the smoke exhaust port in an openable and closable manner. The charge port is disposed on a body of the vehicle. The smoke exhaust duct is coupled to the smoke exhaust port and the charge port. The smoke exhaust duct has an opening at a region of the smoke exhaust duct. The region overlaps the valve part when the valve part is open. The valve part includes a claw disposed at a region of the valve part. The region allows the claw to come into contact with an edge of the opening when the valve part is open.

### CROSS-REFERENCE TO RELATED APPLICATIONS

The present application claims priority from Japanese Patent Application No. 2022-181755 filed on Nov. 14, 2022, the entire contents of which are hereby incorporated by reference.

### BACKGROUND

The disclosure relates to a vehicle including a cooling mechanism for a secondary battery.

Electric vehicles include a high-voltage battery pack including a lithium-ion secondary battery as a source of energy. The high-voltage battery pack stores high energy and may possibly ignite if, for example, contact or a short-circuit occurs. If a temperature of an electrolytic solution in the lithium-ion secondary battery exceeds a boiling point, the lithium-ion secondary battery can generate smoke. To suppress an increase in internal pressure of the high-voltage battery pack due to generation of smoke, a smoke exhaust duct is to be provided in the electric vehicles. For example, reference is made to Japanese Unexamined Patent Application Publication (JP-A) No. 2013-135720, International Patent Application Publication WO 2013/187277, and JP-A No. 2020-119649.

### SUMMARY

An aspect of the disclosure provides a vehicle including a high-voltage battery pack, a charge port, and a smoke exhaust duct. The high-voltage battery pack includes a smoke exhaust port and a valve part. The valve part is configured to close the smoke exhaust port in an openable and closable manner. The charge port is disposed on a body of the vehicle. The smoke exhaust duct is coupled to the smoke exhaust port and the charge port. The smoke exhaust duct has an opening at a region of the smoke exhaust duct. The region overlaps the valve part when the valve part is open. The valve part includes a claw disposed at a region of the valve part. The region allows the claw to come into contact with an edge of the opening when the valve part is open.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a schematic example configuration of a vehicle according to one example embodiment of the disclosure.

FIG. 2 is a diagram illustrating a schematic example configuration of a smoke exhaust and water supply mechanism of FIG. 1.

FIG. 3 is a partially enlarged diagram illustrating the smoke exhaust and water supply mechanism of FIG. 2.

FIGS. 4A, 4B, and 4C are diagrams illustrating an example operation of the smoke exhaust and water supply mechanism of FIG. 2.

FIG. 5 is a diagram illustrating an example modification of a schematic configuration of the smoke exhaust and water supply mechanism of FIG. 1.

FIG. 6 is a diagram illustrating an example operation of the smoke exhaust and water supply mechanism of FIG. 5.

FIG. 7 is a diagram illustrating an example operation of the smoke exhaust and water supply mechanism of FIG. 5.

FIG. 8 is a diagram illustrating an example operation of the smoke exhaust and water supply mechanism of FIG. 5.

### DETAILED DESCRIPTION

In recent years, on an assumption of an unexpected fire incident of electric vehicles, a battery pack structure has been studied that is easy to extinguish fire if a lithium-ion secondary battery ignites. However, currently, if a high-voltage battery pack generates smoke or ignites, water is to be poured over a housing of the high-voltage battery pack or the entire electric vehicle is to be submerged in water to cool or extinguish fire.

It is desirable to provide a vehicle that makes it possible to more efficiently deal with smoke generation or ignition of a high-voltage battery pack.

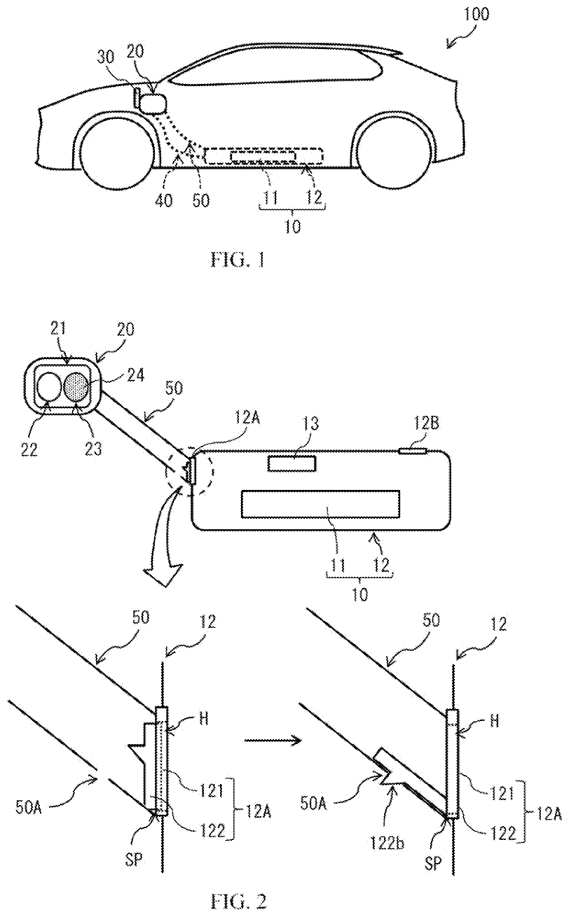

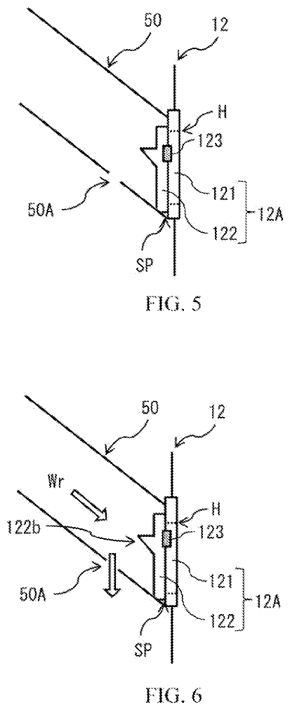

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. The description is given in the following order.
1. Example Embodiment (FIGS. 1 to 4)
2. Modifications (FIGS. 5 to 8)

### 1. Example Embodiment

### [Configuration]

FIG. 1 is a diagram illustrating an example schematic configuration of a vehicle 100 according to an example embodiment of the disclosure. The vehicle 100 may be an electric vehicle that travels with a battery 10 serving as a power source. In one embodiment, the battery 10 may serve as a “high-voltage battery pack”. The vehicle 100 may include the battery 10 and an electric motor for traveling. The electric motor may drive the drive wheels by energy from the battery 10. The battery 10 may be charged by a battery charger provided separately from the vehicle 100.

The battery 10 may be a high-voltage battery pack including, for example, a secondary battery 11, a detector 13, and a housing 12. The detector 13 may detect smoke. The housing 12 may house the secondary battery 11 and the detector 13 as illustrated in FIG. 2. The secondary battery 11 may be, for example, a battery stack including multiple lithium-ion secondary batteries stacked on one another. A charging cable 40 may be coupled to the secondary battery 11. The charging cable 40 may transmit charging power to the secondary battery 11. The charging cable 40 may include one or more power cables. The detector 13 may include a sensor and an output circuitry. The sensor may detect smoke. The output circuit may output an output (a detection signal) from the sensor to a lid 30, which will be described later.

The housing 12 may include, for example, a resin member or a metal member. The housing 12 may protect the secondary battery 11 and the detector 13 from an impact from an outside. The housing 12 may have a space in addition to the secondary battery 11 and the detector 13. The housing 12 may include a smoke exhaust port 12A and a drain outlet 12B. In one embodiment, the smoke exhaust port 12A may serve as a “smoke exhaust port”. A smoke exhaust duct 50, which will be described later, may be coupled to the smoke exhaust port 12A. In one embodiment, the smoke exhaust duct 50 may serve as a “smoke exhaust duct”. Water that has filled the housing 12 may be discharged through the drain outlet 12B. The smoke exhaust port 12A may be on, for example, a side face or a top face of the housing 12. The drain outlet 12B may be on, for example, aside face or the top face of the housing 12. The drain outlet 12B may be provided with a lid that closes the drain outlet 12B in an openable and closable manner.

The smoke exhaust port 12A may include, for example, a support 121 and a valve part 122. In one embodiment, the support 121 may serve as a “support”. In one embodiment, the valve part 122 may serve as a “valve part”. The valve part 122 may be pivotally coupled to the support 121 as illustrated in FIG. 2. A region of the valve part 122 coupled to the support 121 may serve as a supporting point SP of the valve part 122 according to structural dynamics. Furthermore, one end of the smoke exhaust duct 50, which will be described later, may be coupled to the support 121. In the smoke exhaust port 12A, for example, a region of the valve part 122 other than the region (the supporting point SP), of the valve part, coupled to the support 121 may further be secured to the support 121 by frictional force in a normal condition as illustrated in FIG. 2. For example, as illustrated in FIG. 2, when the support 121 has an opening H, the valve part 122 may be fitted to the opening H of the support 121 to be secured to the support 121 by the frictional force.

If force applied to the valve part 122 by pressure in the housing 12 exceeds the above-mentioned frictional force, for example, the valve part 122 may be detached from the support 121 and close a later-described drain outlet 50A of the smoke exhaust duct 50 due to momentum caused when the valve part 122 is detached from the support 121 as illustrated in FIG. 2. In one embodiment, the drain outlet 50A may serve as an “opening”. When the valve part 122 closes the drain outlet 50A of the smoke exhaust duct 50, or when the valve part 122 is open, the valve part 122 may be secured to the drain outlet 50A by frictional force. In the following, a state in which the valve part 122 is secured to the support 121 will be referred to as a state in which the valve part 122 is closed. A state in which the valve part 122 is detached from the support 121 will be referred to as a state in which the valve part 122 is open.

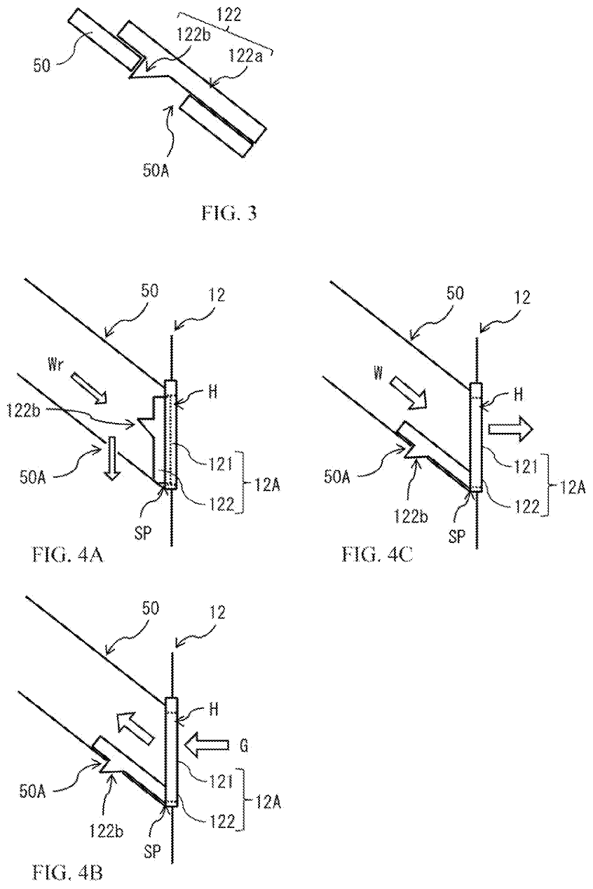

The valve part 122 may include, for example, a plate 122a and a claw 122b as illustrated in FIG. 3. The plate 122a may be configured to close an end of the smoke exhaust duct 50 when the valve part 122 is closed and to close the drain outlet 50A of the smoke exhaust duct 50 when the valve part 122 is open. In one embodiment, the claw 122b may serve as a “claw”. The claw 122b may be disposed on a region of the plate 122a other than an edge. The claw 122b is disposed at a region, of the plate 122a, that allows the claw 122b to come into contact with an edge of the drain outlet 50A when the valve part 122 is open. This makes it possible for the claw 122b to be secured to the drain outlet 50A of the smoke exhaust duct 50 by the frictional force. For example, as illustrated in FIG. 3, the claw 122b may be secured to a region of a rim of the drain outlet 50A farthest from the smoke exhaust port 12A by the frictional force.

As illustrated in FIG. 1, the vehicle 100 may further include, for example, a charge port 20, the lid 30, the charging cable 40, and the smoke exhaust duct 50. In one embodiment, the charge port 20 may serve as a “charge port”. The charge port 20 is disposed on a body of the vehicle 100. The lid 30 may close the charge port 20 in an openable and closable manner. The charge port 20 may be disposed at a position on the body higher than the battery 10. The charging cable 40 may be coupled to the secondary battery 11 and the charge port 20. The charging cable 40 may be disposed outside the smoke exhaust duct 50. That is, the charging cable 40 may be provided separately from the smoke exhaust duct 50. The smoke exhaust duct 50 is coupled to the smoke exhaust port 12A and the charge port 20.

The charge port 20 may include an inlet 21. The inlet 21 may include, for example, molded resin. The inlet 21 may include a receptacle 22 and a socket 23. The receptacle 22 may couple the charging cable 40 to the battery charger. The socket 23 may secure an end of the smoke exhaust duct 50 at the charge port 20. The receptacle 22 and the socket 23 may be, for example, disposed at different positions from each other within the inlet 21 as illustrated in FIG. 2. The socket 23 may be configured to directly couple a fire extinguishing agent supplier, such as a water discharge hose for firefighting, located outside the vehicle 100.

The charge port 20 may further include, for example, a cap 24 that covers the end of the smoke exhaust duct 50 at the charge port 20 as illustrated in FIG. 2. The cap 24 may be attachable and detachable. The cap 24 may be secured to the socket 23 in an openable and closable manner, for example. The cap 24 may open the end of the smoke exhaust duct 50 at the charge port 20 if the pressure in the housing 12 exceeds a predetermined threshold. The cap 24 may be secured to the socket 23 by, for example, frictional force. If force applied to the cap 24 by the pressure in the housing 12 exceeds the above-mentioned frictional force, the cap 24 may open the end of the smoke exhaust duct 50 at the charge port 20.

The lid 30 may open the charge port 20 at a predetermined point in time in response to, for example, receiving a predetermined detection signal from the detector 13. The predetermined detection signal may be a signal indicating that smoke is detected. This may cause the lid 30 to open if, for example, smoke is generated from the secondary battery 11.

The smoke exhaust duct 50 may be, for example, a cylindrical pipe as illustrated in FIG. 2. The smoke exhaust duct 50 may have the drain outlet 50A near the smoke exhaust port 12A for example. Dew condensation water generated in the smoke exhaust duct 50 may be discharged through the drain outlet 50A. The drain outlet 50A may be an opening that couples a space in the smoke exhaust duct 50 to an outside of the smoke exhaust duct 50. The drain outlet 50A is disposed at, for example, a region that overlaps the valve part 122 when the valve part 122 is open. The drain outlet 50A may be disposed at, for example, a region of the smoke exhaust duct 50 that opposes a ground. The claw 122b may be secured to the rim of the drain outlet 50A by the frictional force upon detachment of the valve part 122 from the support 121.

### [Operation]

FIGS. 4A to 4C illustrate an example operation of a smoke exhaust and water supply mechanism.

Assume that, for example, dew condensation water Wr is generated in the smoke exhaust duct 50 in the normal condition as illustrated in FIG. 4A. At this time, the valve part 122 may be secured to the support 121 by the frictional force, and the smoke exhaust port 12A may be closed by the valve part 122. This may allow the dew condensation water Wr in the smoke exhaust duct 50 to be discharged to the outside through the drain outlet 50A and prevent the dew condensation water Wr from entering the battery 10.

Assume that the secondary battery 11 is ignited due to, for example, contact or a short-circuit, and smoke is generated from the secondary battery 11. In this case, smoke gas G may fill the housing 12, which may increase the pressure in the housing 12. As a result, if force applied to the valve part 122 by pressure of the smoke gas G exceeds the above-mentioned frictional force, for example, the valve part 122 may be detached from the support 121 and close the drain outlet 50A of the smoke exhaust duct 50 due to momentum caused when the valve part 122 is detached from the support 121 as illustrated in FIG. 4B. At this time, the claw 122b may be secured to the drain outlet 50A of the smoke exhaust duct 50 by frictional force.

Thereafter, someone such as a firefighter may couple a fire extinguishing agent supplier, such as a water discharge hose for firefighting, located outside the vehicle 100 to the socket 23, and for example, cause firefighting water W to flow into the smoke exhaust duct 50 through the socket 23 as illustrated in FIG. 4C. This may cause the firefighting water W to flow through the smoke exhaust duct 50 into the housing 12. As a result, the firefighting water W may come into direct contact with the secondary battery 11, causing the secondary battery 11 to be cooled. Thereafter, when the space in the housing 12 is filled with the firefighting water W, the firefighting water W may be discharged through the drain outlet 12B. In this manner, the smoke may be exhausted, and water may be supplied using the smoke exhaust duct 50.

Note that the valve part 122 may be secured to the drain outlet 50A by the frictional force of the claw 122b. This may prevent the valve part 122 from being detached from the drain outlet 50A by the firefighting water W.

### Example Effects

Example effects of the vehicle 100 will now be described.

Electric vehicles include a high-voltage battery pack including a lithium-ion secondary battery as a source of energy. The high-voltage battery pack stores high energy and may possibly ignite if, for example, contact or a short-circuit occurs. If a temperature of an electrolytic solution in the lithium-ion secondary battery exceeds a boiling point, the lithium-ion secondary battery can generate smoke. To suppress an increase in internal pressure of the high-voltage battery pack due to generation of smoke, a smoke exhaust duct is to be provided in the electric vehicles.

In recent years, on the assumption of an unexpected fire incident of electric vehicles, a battery pack structure has been studied that is easy to extinguish fire if the lithium-ion secondary battery ignites. However, currently, if the high-voltage battery pack generates smoke or ignites, water is to be poured over a housing of the high-voltage battery pack or the entire electric vehicle is to be submerged in water to cool or extinguish fire.

In the example embodiment, in contrast, the smoke exhaust duct 50 is coupled to the smoke exhaust port 12A of the battery 10 and the charge port 20 of the body. The smoke exhaust duct 50 includes the drain outlet 50A at a region, of the smoke exhaust duct 50, that overlaps the valve part 122 when the valve part 122 is open. Furthermore, the smoke exhaust port 12A is provided with the valve part 122, which closes the smoke exhaust port 12A. The valve part 122 includes the claw 122b at a position that allows the claw 122b to come into contact with the edge of the drain outlet 50A when the valve part 122 is open. The claw 122b may be secured to the smoke exhaust port 12A by the frictional force. This makes it possible for the dew condensation water Wr in the smoke exhaust duct 50 to be discharged to the outside through the drain outlet 50A without entering the battery 10 in the normal condition. Furthermore, if ignition or generation of smoke occurs, the valve part 122 may be detached from the support 121 in accordance with an increase in the pressure in the housing 12 due to the smoke gas G generated from the secondary battery 11, and close the drain outlet 50A of the smoke exhaust duct 50 due to momentum caused when the valve part 122 is detached from the support 121. This helps to discharge the smoke gas G to the outside through the drain outlet 50A.

In some embodiments, if ignition or generation of smoke occurs, the claw 122b may be secured to the drain outlet 50A of the smoke exhaust duct 50 by the frictional force. This may prevent the valve part 122 from being detached from the drain outlet 50A and closed due to the firefighting water W even when the firefighting water W flows into the smoke exhaust duct 50 through the socket 23. As a result, it is possible to allow the firefighting water W to flow into the housing 12 through the smoke exhaust duct 50, making it possible for the firefighting water W to be directly supplied to the secondary battery 11. In this manner, the example embodiment makes it possible for the firefighting water W to be directly supplied to the secondary battery 11 in addition to making it possible to exhaust smoke and extinguish fire by a single smoke exhaust duct 50. This helps to efficiently deal with smoke generation or ignition of the battery 10.

In some embodiments, the claw 122b may be disposed on a region of the plate 122a other than the end. This makes it possible for the claw 122b to be more firmly secured to the drain outlet 50A. As a result, the valve part 122 may be prevented from being detached from the drain outlet 50A due to the firefighting water W even when the firefighting water W flows into the smoke exhaust duct 50 through the socket 23. As a result, it is possible to allow the firefighting water W to flow into the housing 12 through the smoke exhaust duct 50, making it possible for the firefighting water W to directly come into contact with the secondary battery 11 and cool the secondary battery 11. This helps to efficiently deal with smoke generation or ignition of the battery 10.

In some embodiments, the inlet 21 may be disposed at the charge port 20. The inlet 21 may include the receptacle 22 and the socket 23. The receptacle 22 may couple the charging cable 40 to the battery charger. The socket 23 may secure the end of the smoke exhaust duct 50 at the charge port 20. This helps to efficiently exhaust smoke or extinguish fire without greatly changing the existing design.

In some embodiments, the socket 23 may be configured to directly couple a fire extinguishing agent supplier, such as a water discharge hose for firefighting, located outside the vehicle 100 to the socket 23. This helps to efficiently extinguish fire.

### 2. Modifications

Although some example embodiments of have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

### Modification A

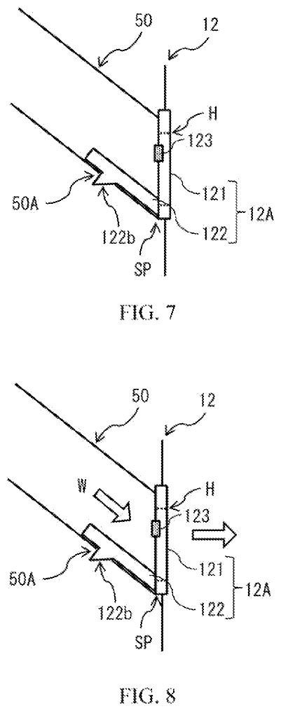

In the above example embodiment, the valve part 122 may be secured to the support 121 by the frictional force in the normal condition. In some embodiments, the valve part 122 may be secured to the support 121 using an adhesive 123 in the normal condition as illustrated in FIG. 5 for example. In some embodiments, the adhesive 123 may serve as an “adhesive”. At this time, at least part of the region of the valve part 122 other than the region (the supporting point SP), of the valve part 122, coupled to the support 121 may be secured to the support 121 using the adhesive 123 in the normal condition. For example, as illustrated in FIG. 5, when the support 121 has the opening H, the valve part 122 may cover the opening H. and the valve part 122 and the support 121 may be secured to each other by the adhesive 123. In this case also, for example, as illustrated in FIG. 6, it is possible to discharge the dew condensation water Wr generated in the smoke exhaust duct 50 to the outside through the drain outlet 50A and further to prevent the dew condensation water Wr from entering to the inside of the battery 10.

In this modification, the adhesive 123 may melt due to heat of the smoke gas G generated from the secondary battery 11. When force applied to the valve part 122 by the pressure of the smoke gas G exceeds securing force of the adhesive 123, for example, the valve part 122 may be detached from the support 121 and close the drain outlet 50A of the smoke exhaust duct 50 due to momentum caused when the valve part 122 is detached from the support 121 as illustrated in FIG. 7. When the valve part 122 closes the drain outlet 50A of the smoke exhaust duct 50, or when the valve part 122 is open, the valve part 122 may be secured to the drain outlet 50A by frictional force. This makes it possible to prevent, for example, the valve part 122 from being detached from the drain outlet 50A due to the firefighting water W as illustrated in FIG. 8.

### Modification B

In the above example embodiment, the drain outlet 50A may be provided to discharge the dew condensation water Wr. In some embodiments, the drain outlet 50A may be provided to discharge rainwater that has entered the smoke exhaust duct 50 instead of the dew condensation water Wr. Alternatively, in the above example embodiment, the drain outlet 50A may be provided to discharge rainwater that has entered the smoke exhaust duct 50 in addition to the dew condensation water Wr.

### Modification C

In the above example embodiment, the charging cable 40 may be disposed outside the smoke exhaust duct 50. In some embodiments, the charging cable 40 may be disposed inside the smoke exhaust duct 50.

### Modification D

In the above example embodiment, the receptacle 22 and the socket 23 may be disposed at different positions from each other within the inlet 21. In some embodiments, the socket 23 may surround the receptacle 22. In this case, the receptacle 22 and the socket 23 may be disposed concentrically.

### Modification E

In some embodiments, a detector that detects pressure in the housing 12 may be provided instead of the detector 13, which detects smoke. In this case, the lid 30 may open at a predetermined point in time in response to receiving a predetermined detection signal from the detector, which detects the pressure in the housing 12. For example, the predetermined detection signal may be a signal indicating that a predetermined pressure has been detected. As a result, it is possible to release the smoke gas G to the outside through the charge port 20.

### Modification F

In the above example embodiment and modifications thereof, the vehicle 100 may be an electric vehicle. In some embodiments, the vehicle 100 may be a hybrid electric vehicle that includes an engine operable by, for example, gasoline or light oil and an electric motor for traveling. In this case also, it is possible to achieve example effects similar to those of one or more of the above example embodiment and modifications thereof.

### Modification G

In some embodiments, instead of the drain outlet 50A, an opening that is for a use different from that of the drain outlet 50A may be provided in the smoke exhaust duct 50. The opening may have a structure similar to that of the drain outlet 50A. In this case also, it is possible to achieve example effects similar to those of one or more of the above example embodiment and modifications thereof.

The effects described herein are mere examples, and example effects of the disclosure are therefore not limited to those described herein. Accordingly, the disclosure may achieve any other effect.

Furthermore, the disclosure may encompass at least the following embodiments.

(1) A vehicle including:
a high-voltage battery pack including a smoke exhaust port and a valve part, the valve part being configured to close the smoke exhaust port in an openable and closable manner;
a charge port disposed on a body of the vehicle; and
a smoke exhaust duct coupled to the smoke exhaust port and the charge port, in which
the smoke exhaust duct has an opening at a region, of the smoke exhaust duct, that overlaps the valve part when the valve part is open, and
the valve part includes a claw disposed at a region, of the valve part, that allows the claw to come into contact with an edge of the opening when the valve part is open.

(2) The vehicle according to (1), in which
the valve part includes a plate configured to close the opening when the valve part is open, and
the claw is disposed at a region, of the plate, that allows the claw to come into contact with the edge of the opening when the valve part is open.

(3) The vehicle according to (1) or (2), in which
the charge port includes an inlet including a receptacle and a socket, the receptacle being configured to couple one or more power cables coupled to the high-voltage battery pack to a battery charger provided outside the vehicle, the socket being configured to secure an end of the smoke exhaust duct at the charge port, and
the socket is configured to be directly coupled to a fire extinguishing agent supplier provided outside the vehicle.

(4) The vehicle according to any one of (1) to (3), further including a support to which the valve part is pivotally coupled, in which
a region of the valve part other than a region, of the valve part, pivotally coupled to the support is configured to be secured to the support by frictional force.

(5) The vehicle according to any one of (1) to (3), further including:
a support to which the valve part is pivotally coupled; and an adhesive configured to secure, to the support, at least part of a region of the valve part other than a region, of the valve part, pivotally coupled to the support.

As used herein, the term “collision” may be used interchangeably with the term “contact”.

1. A vehicle comprising:
a high-voltage battery pack comprising a smoke exhaust port and a valve part, the valve part being configured to close the smoke exhaust port in an openable and closable manner;
a charge port disposed on a body of the vehicle; and
a smoke exhaust duct coupled to the smoke exhaust port and the charge port, wherein
the smoke exhaust duct has an opening at a region of the smoke exhaust duct, the region overlapping the valve part when the valve part is open, and
the valve part comprises a claw disposed at a region of the valve part, the region allowing the claw to come into contact with an edge of the opening when the valve part is open.

2. The vehicle according to claim 1, wherein
the valve part comprises a plate configured to close the opening when the valve part is open, and
the claw is disposed at a region of the plate, the region allowing the claw to come into contact with the edge of the opening when the valve part is open.

3. The vehicle according to claim 1, wherein
the charge port comprises an inlet comprising a receptacle and a socket, the receptacle being configured to couple one or more power cables coupled to the high-voltage battery pack to a battery charger provided outside the vehicle, the socket being configured to secure an end of the smoke exhaust duct at the charge port, and
the socket is configured to be directly coupled to a fire extinguishing agent supplier provided outside the vehicle.

4. The vehicle according to claim 1, further comprising a support to which the valve part is pivotally coupled, wherein
a first region of the valve part other than a second region of the valve part, the second region being pivotally coupled to the support is configured to be secured to the support by frictional force.

5. The vehicle according to claim 1, further comprising:
a support to which the valve part is pivotally coupled; and
an adhesive configured to secure, to the support, at least part of a first region of the valve part other than a second region of the valve part, the second region being pivotally coupled to the support.
